(19) United States
(12) Patent Application Publication
(10) Pub. No.: US 2010/0329438 A1
(43) Pub. Date: Dec. 30, 2010

(54) METHOD AND APPARATUS FOR USER EQUIPMENT TO PROCESS CALLING PARTY INFORMATION

(75) Inventors: Jian Yang, Shenzhen (CN); Shunan Fan, Shenzhen (CN)

Correspondence Address: STAAS & HALSEY LLP, SUITE 700, 1201 NEW YORK AVENUE, N.W., WASHINGTON, DC, 20005, US

(73) Assignee: HUAWEI TECHNOLOGIES CO., LTD., Shenzhen (CN)

(21) Appl. No.: 12/874,665

(22) Filed: Sep. 2, 2010

Related U.S. Application Data
(63) Continuation of application No. PCT/CN2009/070819, filed on Mar. 17, 2009.

(30) Foreign Application Priority Data
Mar. 19, 2008 (CN) 200810084358.1

(51) Int. Cl. H04M 1/56

(52) U.S. Cl. 379/142.01

(57) ABSTRACT

A method and an apparatus for a User Equipment (UE) to process calling party information are disclosed. The method includes: obtaining capability information of a called UE; and sending calling party information compliant with the capability information to the called UE so that the called UE can process the calling party information. Through the embodiments of the present invention, the calling party information compliant with the capability information of the called UE is sent according to the capability information, and therefore, the called UE can process the calling party information normally and avoid sending futile information, thus reducing waste of information resources and improving the user experience.

### CROSS-REFERENCE TO RELATED APPLICATIONS

This application is a continuation of International Application No. PCT/CN2009/070819, filed on Mar. 17 , 2009, which claims priority to Chinese Patent Application No. 200810084358.1, filed with the Chinese Patent Office on Mar. 19, 2008, both of which are hereby incorporated by reference in their entireties.

### FIELD OF THE INVENTION

The present invention relates to communication technologies, and in particular, to a method and an apparatus for a User Equipment (UE) to process calling party information.

### BACKGROUND OF THE INVENTION

Name identifier is set by the mobile subscriber in order to display the name of the calling party. The name identifier that the calling party expects to display is known as a calling party identifier, and the maximum length of the calling party name identifier is about 80 characters. A Presentation Indicator (PI) comes in two types: presentation restriction, and null name.

Calling Name Presentation (CNAP) is a service of presenting calling party information. It is a supplementary service that presents the calling party information to the called party in the process of creating a call. The calling party itself does not initiate or activate presentation of the calling name identifier. The calling name presentation is offered to the called party only if the calling party has activated this service. If the calling party subscribes to no presentation of the calling name identifier, the calling name identifier is not presented to the called party. The network invokes the CNAP supplementary service automatically. The calling party information is presented to the called party only if the called party has subscribed to the service of presenting the calling party information.

A Facility message is sent by a server or UE for requesting or notifying a supplementary service. The Facility message carries information elements for invoking and operating the supplementary services, and such services are identified by the corresponding operation codes. Some information elements (such as user's calling information identifier, or identifier indicating whether to present the calling party information) may be appended to the indicated service.

A Mobile Switching Center (MSC) is a place for providing call switching and call control between the call system and the data system. The MSC exists only in a Circuit-Switched (CS) domain, and is designed to connect the wireless system and perform all functions of circuit-switched calls, for example, control call connection, manage the communication services of the UE in the local network or other networks such as Public Switched Telephone Network (PSTN)/Integrated Services Digital Network (ISDN)/Packet Switched Public Data Network (PSPDN), and provide charging information.

A User Agent Profile (UAProf) server is a server capable of storing information such as user capability information, and is connected with the MSC server.

For various reasons, many people reject to answer unidentifiable calls, which may lead to losses to the persons who originate the calls, especially, the calls made for commercial purposes. Since the called party fears that the unidentifiable calls may be insecure or unexpected, they may reject unidentifiable calls, and then miss some important calls. As a result, a calling information to presentation service is launched as a new supplementary service.

In the calling information presentation service, the calling party information is presented to the called party, and the calling party may set restriction of presenting its information to the called party in order to protect privacy of the calling number or identity; and the called party may subscribe to the service of presenting the calling party information. This solution is known as CNAP service. According to specific conditions, the subscriber chooses whether to publish the expected information to the called party, or chooses the content of the information to be presented to the called party. This service is applicable to various organizations, large enterprises, or persons, and helps promote brands.

The information may be presented to the called party in the process of ringing or after the ringing; or information about the calling party is prompted to the called party by other means. If the information is the name of the calling party, the name may be presented in the form of characters. The calling party information is stored in a database of the originator or a database of a central intelligent network, or delivered together with the call.

In the process of developing the present invention, the inventor finds at least the following problems in the prior art:

In the process of carrying out this service, if the name identifier in the calling party information is English, the calling party information can be presented by the UE normally; if the name identifier in the calling party information is Chinese, the calling party information cannot be processed normally, or is discarded by the server because it is not identifiable to the server. Consequently, the called party is unable to receive the calling party information. Alternatively, the capabilities of the UE do not support the delivered calling party information, and the UE is unable to process the calling party information normally.

### SUMMARY OF THE INVENTION

The embodiments of the present invention provide a method and an apparatus for a UE to process calling party information in order to enable the called UE to process the calling party information sent by the calling UE normally, save information resources, and improve user experience.

To fulfill the foregoing objectives, one aspect of the present invention is to disclose a method for a UE to process calling party information. The method includes:

obtaining capability information of a called UE; and

sending calling party information compliant with the capability information to the called UE so that the called UE can process the calling party information.

Another aspect of the present invention is to provide an apparatus for a UE to process calling party information. The apparatus includes:

a called party information obtaining module, adapted to obtain capability information of called UE;

a calling party information converting module, adapted to convert the calling party information obtained from calling UE according to the capability information obtained by the called party information obtaining module; and

a calling party information sending module, adapted to send the calling party information compliant with the capability information obtained by the called party information obtaining module to the called UE after the calling party information converting module converts the calling party information so that the called UE can process the calling party information.

Compared with the prior art, the technical solution under the present invention brings these benefits: The calling party information compliant with the capability information of the called UE is sent to the called UE and processed by the called UE. Therefore, the called UE can process the calling party information normally, it is avoided that information resources are wasted due to incapability of the called UE in processing the calling party information, and the user experience is improved. Meanwhile, the server provides a conversion function which converts the calling party information into a format supported by the called UE or the called network.

### BRIEF DESCRIPTION OF THE DRAWINGS

FIGS. 1A and 1B show a flowchart of a method for sending calling party information in embodiment one of the present invention;

FIGS. 2A and 2B show a flowchart of a method for requesting the called UE to feed back capability information and the UE processing calling party information accordingly in embodiment two of the present invention;

FIGS. 3A and 3B show a flowchart of a method for retrieving registered capability information from a server and the UE processing calling party information accordingly in embodiment three of the present invention;

FIG. 4 shows a structural diagram of an apparatus for a UE to process calling party information in embodiment four of the present invention;

FIGS. 5A and 5B show a flowchart of a method for sending calling party information in embodiment five of the present invention;

FIGS. 6A and 6B show a method for requesting the called UE to feed back capability information and the UE processing calling party information accordingly in embodiment six of the present invention;

FIGS. 7A and 7B show a flowchart for retrieving registered capability information from a sever and the UE processing calling party information accordingly in embodiment seven of the present invention; and

FIG. 8 shows a structural diagram of an apparatus for a UE to process calling party information in embodiment eight of the present invention.

### DETAILED DESCRIPTION OF THE EMBODIMENTS

The embodiments of the present invention provide a method and an apparatus for a UE to process calling party information. Therefore, after activating this service, the called UE can process the calling party information normally, where the calling party information can be a text in English and/or Chinese or multimedia identifier information such as voice, video, and pictures.

The method provided herein overcomes the problem that the UE is unable to process calling party information. Meanwhile, the correct calling party information is sent according to capabilities of the called UE. Therefore, the calling party information can be processed by the called UE normally, and the information resource waste caused by sending of unnecessary information is reduced. For example, for called UE which has subscribed to the service of processing calling party information and supports both Chinese and English but supports no multimedia display, only calling party information in Chinese is sent, and no calling party information in English or in multimedia format is sent any more, thus avoiding transmission of futile information.

The technical solution under the present invention overcomes the problem that the called UE is unable to process the calling party information, and makes the service forward-compatible.

The embodiments of the present invention are implemented through cooperation between the network device, UE, and storage server in the existing mobile communication system. The basic conception is:

After a calling UE sends a Setup message, if it is indicated that the calling party information is processible, the MSC does not send the Facility message carrying the calling party information to the called UE immediately after sending the Setup message to the called UE. Instead, the MSC decides whether to send the calling party information, or send the calling party information in Chinese and/or English, and/or multimedia, and/or video, and/or audio after receiving an Alerting message returned.

After the calling UE sends the Setup message, if it indicated that the calling party information is processible, the MSC queries a server such as UAprof server about the capability information of the called UE, and judges whether to send the calling party information, or send the calling party information in Chinese and/or English.

The technical solution under the present invention is based on the foregoing basic conception. The detailed process of sending calling party information is described below in embodiment one of the present invention.

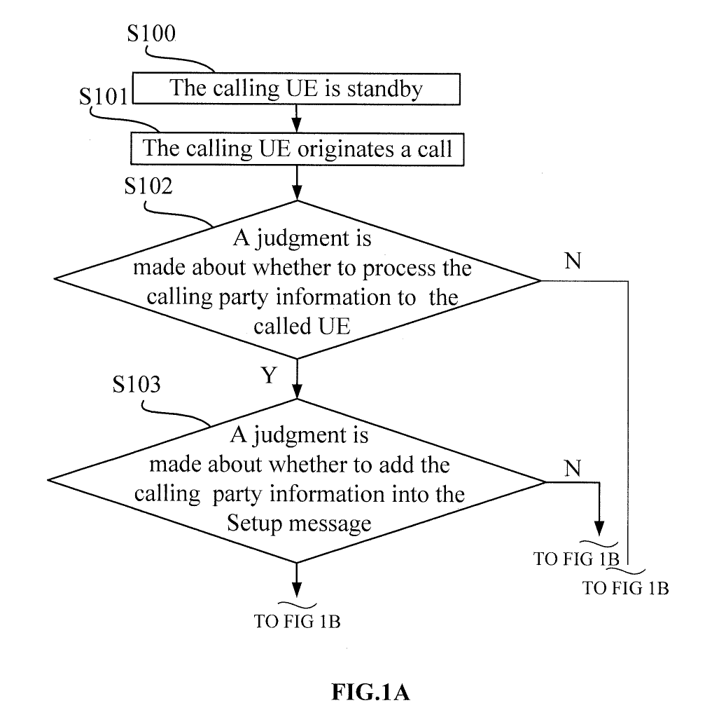

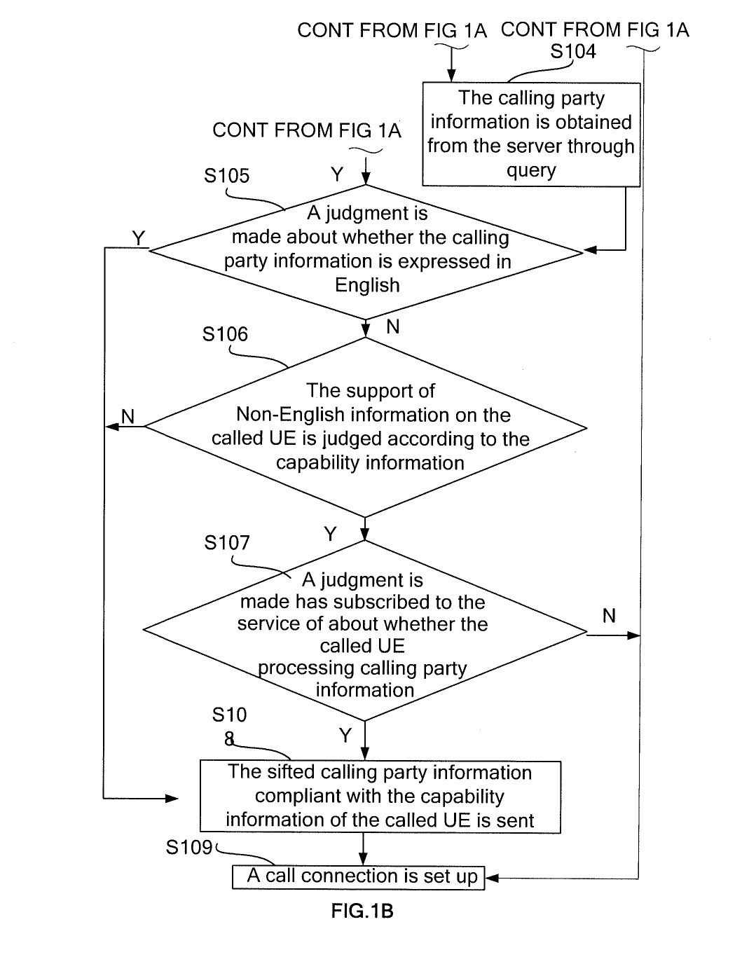

As shown in FIGS. 1A and 1B, in the first embodiment of the present invention, the process of sending calling party information includes the following steps:

For easy understanding, it is assumed that the calling party information is in English and Chinese, which should not be construed as limitation to the protection scope of the present invention. In practical application, the calling party information may be in various languages.

Step S100: The calling UE is standby.

Step S101: The calling UE originates a call.

The calling UE sends a call setup message, namely, Setup message, to request setup of a call connection.

Step S102: A judgment is made about whether to present the calling party information to the called UE.

In practical application, the judgment is based on the setting by the calling party. That is, the calling party can set whether to present the calling party information to the called UE according to their own decisions on whether to present their information.

If it is determined that the calling party information needs to be sent to the called UE, the process proceeds to step S103.

If it is determined that the calling party information does not need to be sent to the called UE, the process proceeds to step S109.

Step S103: A judgment is made about whether to add the calling party information into the Setup message.

According to the user setting, a judgment is made about whether to add the calling party information into the Setup message sent by the calling UE:

If it is not necessary to add the calling party information, the process proceeds to step S104.

If it is necessary to add the calling party information, the process proceeds to step S105.

Step S104: The calling party information is obtained from the server through query.

Further, if the calling party information needs to be obtained from the server, the calling UE needs to register the calling party information onto the server before this step. The registration process may include the information about whether to send the calling party information to the called UE. If this registration mode is applied, the calling UE needs to query the server about the right of sending the calling party information to the called UE when sending the call setup message. All the foregoing improvements based on the technical conception of the present invention are covered in the protection scope of the present invention.

Step S105: A judgment is made about whether the calling party information is in English.

If the calling party information is pure English information, the calling party information is sent directly, and the process proceeds to step S108.

If the calling party information includes non-English information, the process proceeds to step S106.

Further, the English mentioned above refers to the language corresponding to the basic processing capabilities owned by the called UE. In practice, the language varies as required or according to the region of the called UE. The change of the language does not affect the protection scope of the present invention.

Step S106: The capability information of the called UE is obtained, and a judgment is made about whether the called UE supports non-English information.

In this step, the judgment about whether the called UE supports non-English information is made on basis of the capability information of the called UE, and the capability information is obtained by the calling party side. The obtaining method is detailed in the subsequent embodiment.

If the called UE supports only English information and does not support non-English information, the process proceeds to step S108 and only the calling party information in English is sent.

If the called UE supports non-English information, namely, Chinese texts, video, audio, pictures, or any combination thereof, the process proceeds to step S107.

It should be noticed that the step of obtaining the capability information of the called UE may occur at any time after the calling UE originates the call and before the judgment about whether the called UE supports non-English information is made, and may be performed between S101 and S106. The technical solution with steps adjusted is also covered in the protection scope of the present invention.

It should be further noticed that the non-English mentioned above refers to the language type or multimedia format corresponding to the advanced processing capabilities of the called UE. In practice, the language type and/or multimedia format varies as required or according to the region of the called UE. Such change based on the technical conception of the present invention is covered in the protection scope of the present invention.

Step S107: A judgment is made about whether the called UE has subscribed to the service of processing calling party information.

If the called UE has not subscribed to the service of processing calling party information, namely, the called party has not activated or has stopped this service, the process proceeds to step S109.

If the called UE has subscribed to the service of processing calling party information, the process proceeds to step S108.

The service of processing calling party information includes: presenting the calling party information, playing the calling party information in a multimedia format, or filtering the calling party information of the incoming calls, or any combination thereof.

Step S108: The selected calling party information compliant with the capability information of the called UE is sent.

If the capability information of the called UE indicates that the called UE supports only English, the calling party information in English is sent to the called UE.

If the capability information of the called UE indicates that the called UE supports both Chinese and English, the calling party information in Chinese is sent to the called UE.

If the capability information of the called UE indicates that the called UE supports multimedia formats such as audio and/or video, the calling party information in the corresponding multimedia format is sent to the called UE.

If the capability information of the called UE indicates that the called UE supports English and Chinese, and multimedia formats such as audio and/or video, the calling party information in Chinese and the corresponding multimedia format is sent to the called UE.

It should be further noticed that if none of the calling party information formats provided by the calling party is supported by the capability information of the called UE, no calling party information is sent. For example, the called UE supports only English format of the calling party information, but the calling UE provides only Chinese format of the calling party information, the calling party information is not sent, thus avoiding display error caused by unsupported format of the calling party information on the called UE.

Step S109: A call connection is set up.

This step is not intended as primarily protected in the present invention, and is not described in any more detail.

In the example given above, it is assumed that the calling party information in Chinese is preferred. In practice, in addition to presentation of the information, the processing further includes: playing the calling party information in a multimedia format such as a ring tone, triggering the ring tone defined by the calling party or the called party, filtering the calling party information, and judging whether to filter out the incoming call according to the matching result between the calling party information and the information stored in the called UE.

The embodiments of the present invention are described in more detail below with reference to accompanying drawings and preferred embodiments.

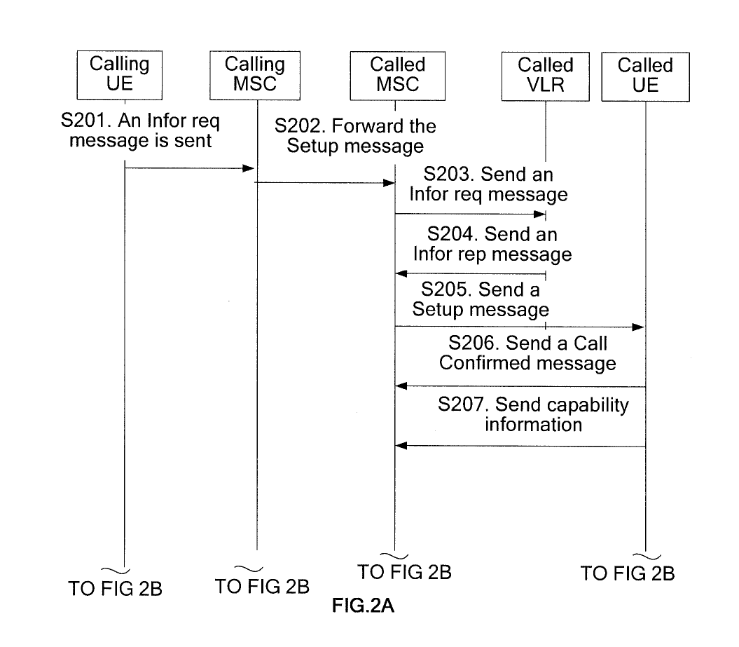

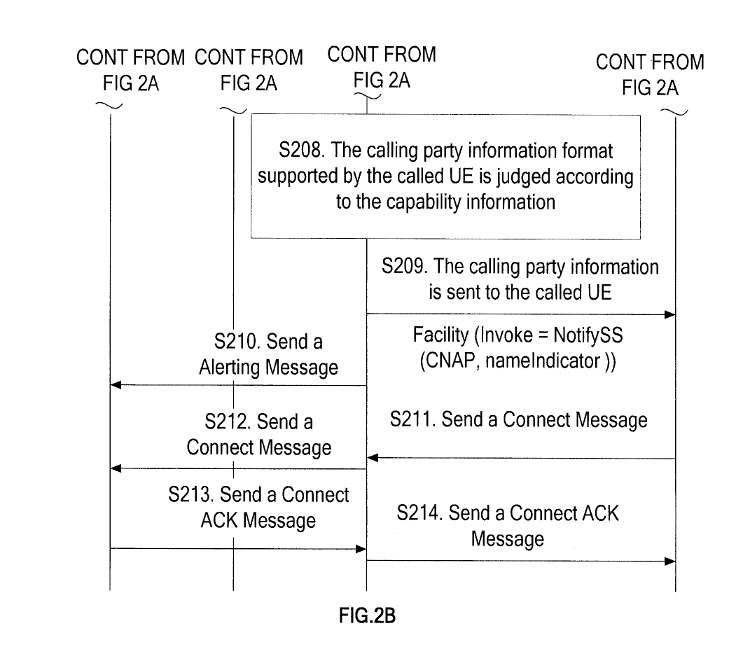

FIGS. 2A and 2B show a flowchart of a method for requesting the called UE to feed back capability information and the UE processing calling party information accordingly in embodiment two of the present invention.

In this embodiment, after a Setup message is sent to the called UE, if the calling party has provided the calling party information and allows sending of the calling party information to the called UE, the network requires the called UE to return a message, which carries the capability information of the called UE and/or indicate whether the called UE has subscribed to this service. The message that carries such information may be an Alerting message, Call Confirmed message, Call Proceeding message, or Facility message.

It should be noticed that the capability information of the called UE includes: hardware information of the called UE, and/or software information of the called UE, and/or version information of the called UE, and/or language information of the called UE, and/or an indication about whether the called UE has subscribed to the service of processing calling party information, and/or an indication about whether the called UE has activated the service of processing calling party information, and/or subscriber profile, and/or subscriber preferences, and/or subscriber level.

In this embodiment, an Alerting message carries an indication of capability information of the UE and/or an indication about whether the called UE has subscribed to this service. Therefore, the network server knows whether the called UE supports Chinese and/or English, obtains the multimedia formats supported by the called UE, and knows whether the called UE has subscribed to this service.

The UE processes the calling party information according to the returned capability information. In addition to presentation of the information, the processing further includes: playing the calling party information in a multimedia format such as a ring tone, triggering the ring tone defined by the calling party or the called party, filtering the calling party information, and judging whether to filter out the incoming call according to the result of matching between the calling party information and the information stored in the called UE.

Specifically, the following exemplary process is detailed to show how the UE processes calling party information compliant with capability information requested from the called UE. The process includes the following steps:

Step S201: The calling UE sends a Setup message to the calling MSC server.

The message may indicate whether to present the calling party information to the called party. If the calling party defines that the calling party information is allowed to be processed to the called party, the Setup message may carry a Facility message and carry the calling party information defined by the calling party as presentation to the called party. The Facility message may be an independent message sent together with the Setup message. The Facility message carries the calling party information defined by the calling party as presentation to the called party.

Step S202: After receiving the message from the calling UE, the calling MSC server forwards the message to the called MSC.

Step S203: The called MSC sends an information request (Infor req) message to the called Visited Location Register (VLR).

After receiving the message from the calling party, the called MSC server sends an information request message to the called VLR, and may query the called VLR whether the called party has activated the service of processing calling party information. This process of querying activation of a supplementary service is optional.

Step S204: The called VLR sends an information response (Infor res) message.

The information returned by the called VLR includes the called party location and an indication about whether the supplementary service is activated or not.

Step S205: The called MSC sends a Setup message to the called UE.

If the calling party provides the calling party information allowed to be presented, and the called party has activated this supplementary service, the Setup message sent by the called VLR to the called party instructs the called party to return capability information, for example, supported language (Chinese and/or English), and/or multimedia message format, and/or an indication about whether the called UE has subscribed to this service.

Step S206: The called UE returns a Call Confirmed message to the calling UE.

Step S207: The called UE sends an Alerting message that carries the capability information.

The called UE sends an Alerting message to the calling UE. The Alerting message may be a normal Alerting message. The Alerting message may indicate the capabilities of the UE, for example, whether the UE supports Chinese and/or English, whether the UE has subscribed to the service.

Step S208: The calling party information format supported by the called UE is judged according to the obtained capability information.

After receiving Alerting message, the called MSC makes the following judgment:

If the Alerting message received by the MSC server is a normal Alerting message, the MSC server sends no calling party information.

If the Alerting message received by the MSC server is an Alerting message that carries an identifier, the MSC server performs the following operations:

A. If the Alerting message indicates that the called UE supports English only, the MSC server sends calling party information in English to the MSC server, and does not send any information in Chinese or any other information unsupported by the called UE.

B. If the called UE supports both Chinese and English and has subscribed to this service, the MSC server sends information in Chinese to the called UE.

C. If the called UE supports Chinese and English and/or multimedia format, and has subscribed to this service, the MSC server sends calling party information in Chinese and/or multimedia format to the called UE.

Step S209: The calling party information is sent to the called UE.

The called MSC sends a Facility message to the called UE according to the judgment result in step S208. If it is determined that the called UE supports the service, the called MSC sends the Facility message related to the calling party information to the called UE.

Step S210: The called MSC sends an Alerting message to the calling UE.

Step S211: The called UE sends a Connect message to the called MSC.

The Facility message related to the calling party information may be sent after this step.

Step S212: The called MSC sends a Connect message to the calling UE.

Step S213: The calling UE sends a Connect ACK message to the called MSC.

Step S214: The called MSC sends a Connect ACK message to the called UE.

The solution disclosed in this embodiment overcomes the problem that the called UE is unable to display the information normally when the calling party information unsupported by the called UE is sent. For example, the MSC server sends the calling party information in Chinese to the called UE only if the called UE supports both Chinese and English and has subscribed to this service. In addition to processing the information in Chinese, depending on the user setting or the UE capabilities, the UE may select the proper and/or best processing mode to bring better user experience.

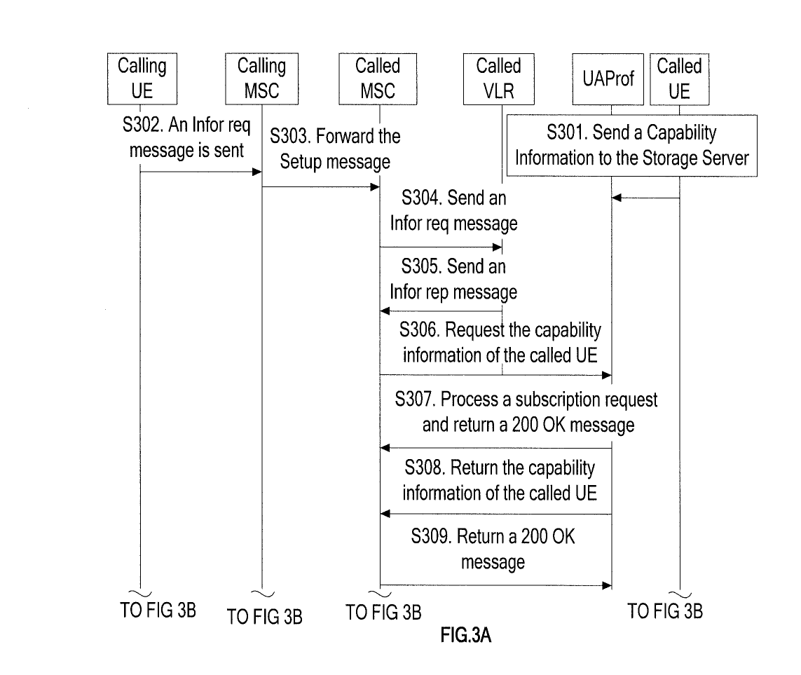

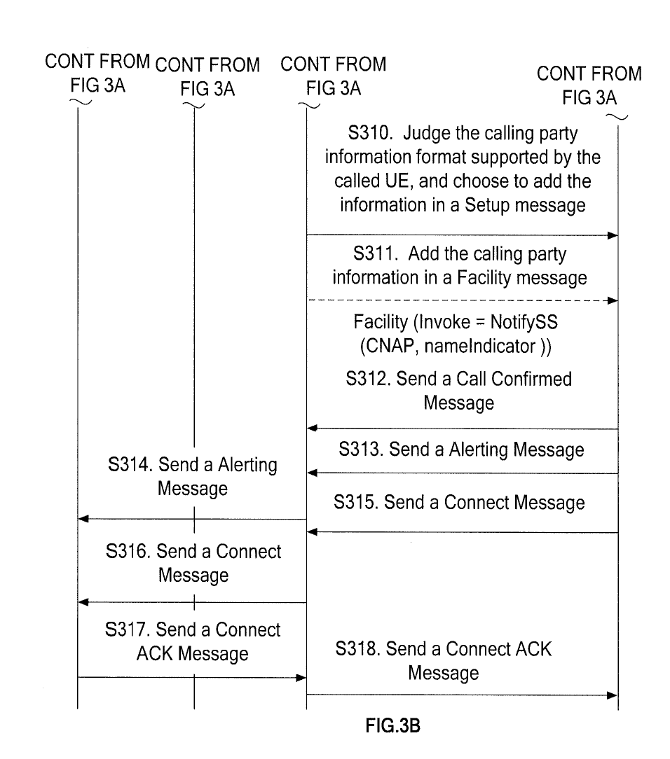

FIGS. 3A and 3B show a flowchart of a method for retrieving registered capability information from a server and the UE processing calling party information accordingly in embodiment three of the present invention.

The UE processes the calling party information according to the returned capability information. In addition to presentation of the information, the UE can play the calling party information in a multimedia format such as a ring tone, trigger the ring tone defined by the calling party or the called party, filter the calling party information, and judge whether to filter out the incoming call according to the result of matching between the calling party information and the information stored in the called UE.

In this embodiment, if the called UE has activated this service, the called UE reports its capability information to the storage server such as UAProf server. The capability information includes: support of the calling party information in Chinese and/or English, and/or information about whether the called UE has subscribed to this service, and/or supported multimedia message format. In this way, if the calling party allows presentation of the calling party information, and/or the called party has subscribed to this service, and/or the calling party provides displayable calling party information, the server queries the storage server about capability information of the called UE, judges whether to send the calling party information to the called UE, and judges the format of the calling party information normally receivable by the called UE.

Detailed below is about how the UE processes calling party information compliant with registered capability information retrieved from the server.

Step S301: The called UE sends its capability information to the storage server.

In this embodiment, a UAProf server is used to report the capability information of the UE. The capability information includes: support of calling party information in Chinese or English, and/or information about whether the UE has subscribed to this service, and/or the multimedia message format that supports the processing of the calling party information.

Step S302: The calling UE sends a Setup message to the called party.

The message may indicate whether to present the calling party information to the called party. If the calling party defines that the calling party information is allowed to be presented to the called party, the Setup message may carry a Facility message and carry the calling party information defined by the calling party as presentation to the called party. The Facility message may be an independent message sent together with the Setup message. The Facility message carries the calling party information defined by the calling party as presentation to the called party.

Step S303: After receiving the message from the calling UE, the calling MSC server forwards the message to the called MSC.

Step S304: The called MSC sends an information request (Infor req) message to the called VLR.

After receiving the message from the calling party, the called MSC server sends an information request message to the called VLR, and may query the called VLR whether the called party has activated the service of processing calling party information. This process of querying activation of a supplementary service is optional.

Step S305: The called VLR sends an information response (Infor res) message.

The information returned by the called VLR includes the called party location and an indication about whether the supplementary service is activated or not.

Step S306: The called MSC requests the capability information of the called UE from the UAProf server.

If the called UE has activated the service of processing calling party information, the called MSC subscribes to the capability information of the called UE from the UAProf server.

Step S307: The UAProf server processes the subscription request, and returns a 200 OK message to confirm the subscription.

Step S308: The UAProf server returns the capability information of the called UE to the called MSC.

The UAProf server sends a NOTIFY request message that carries the capability information of the called UE to the called MSC.

Step S309: The called MSC server returns a 200 OK message.

Step S310: The called MSC server judges the calling party information format supported by the called UE according to the obtained capability information. The capability information may be carried in a Setup message.

A. If the Setup message indicates that the called UE supports English only, the MSC server sends calling party information in English to the MSC server, and does not send any information in Chinese or any other information unsupported by the called UE.

B. If the called UE supports both Chinese and English and has subscribed to this service, the MSC server sends information in Chinese to the called UE.

C. If the called UE supports Chinese and English and/or multimedia format, and has subscribed to this service, the MSC server sends calling party information in Chinese and/or multimedia format to the called UE.

The MSC server converts the proper calling party information or the message that carries the calling party information if the MSC server supports such conversion. In this way, the called UE can receive the calling party information normally. The conversion includes: converting messages, converting the format of the calling party information supported by the called UE, converting the heterogeneous network message, and converting the calling party information into a format acceptable to the called UE.

The conversion of the message that carries the calling party information includes: conversion of any heterogeneous network message, and conversion between any two of the following types of messages: user-to-user message element, INVITE message, Unstructured Supplementary Service Data (USSD), and Facility message.

Step S311: This step is optional. If the calling party information is carried in a Facility message rather than a Setup message, the mode of carrying is the same as that described above.

Step S312: The called UE returns a Call Confirmed message to the called MSC.

Step S313: The called UE sends an Alerting message.

Step S314: The called MSC forwards the Alerting message.

Step S315: The called UE sends a Connect message to the called MSC.

The Facility message related to the calling party information may be sent after this step.

Step S316: The called MSC sends a Connect message to the calling UE.

Step S317: The calling UE sends a Connect ACK message to the called MSC.

Step S318: The called MSC sends a Connect ACK message to the called UE.

In addition to process the information in Chinese, depending on the user setting or the UE capabilities, the UE may select the proper and/or best mode of processing the calling party information.

It should be noticed that the methods disclosed in the first embodiment to the third embodiment above are applicable to the service of processing calling party information in the CS domain calls, and/or videophone, and/or message sessions.

The solution disclosed in this embodiment overcomes this problem: The called UE is unable to display the information normally when the calling party information unsupported by the called UE is sent. For example, the MSC server sends the calling party information in Chinese to the called UE only if the called UE supports both Chinese and English and has subscribed to this service. In fact, in addition to processing the information in Chinese, depending on the user setting or the UE capabilities, the UE may select the proper and/or best processing mode to bring better user experience.

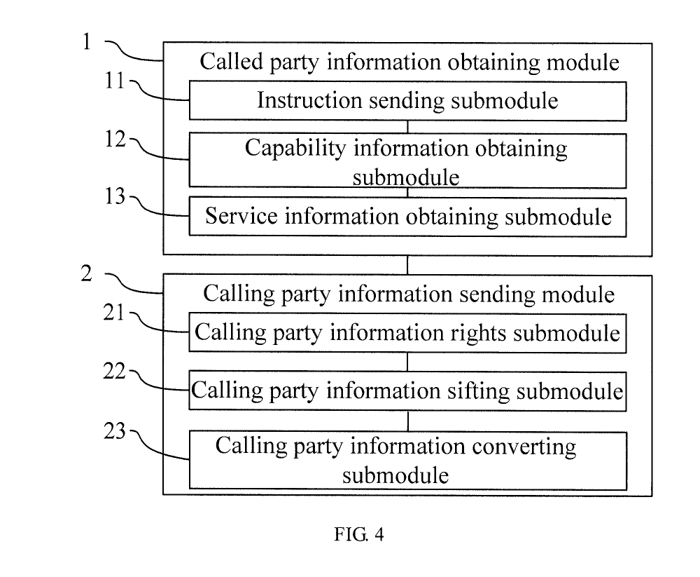

FIG. 4 shows a structural diagram of an apparatus for a UE to process calling party information in embodiment four of the present invention. The apparatus includes:

a called party information obtaining module 1, adapted to obtain capability information of called UE; and

a calling party information sending module 2, adapted to send the calling party information compliant with the capability information obtained by the called party information obtaining module 1 to the called UE so that the called UE can process the calling party information.

The called information obtaining module 1 is further adapted to obtain information about whether the called UE has activated the service of processing the calling party information, and includes:

an instruction sending submodule 11, adapted to send to the called UE or server an instruction of obtaining the capability information of the called UE and/or obtaining information about whether the called UE has activated the service of processing calling party information;

a capability information obtaining submodule 12, adapted to obtain the capability information of the called UE through the message returned by the called UE or server; and

a service information obtaining submodule 13, adapted to obtain information about whether the called UE has activated the service of processing calling party information through the message returned by the called UE or server.

The calling party information sending module 2 further includes:

a calling party information rights submodule 21, adapted to judge whether the called UE is entitled to process calling party information;

a calling party information selecting submodule 22, adapted to select the calling party information compliant with the capability information and/or the message that carries the calling party information according to the capability information obtained by the called party information obtaining module 1 if the calling party information rights submodule 21 determines that the called UE is entitled to process the calling party information; and

a calling party information converting submodule 23, adapted to convert the calling party information or message selected by the calling party information selecting submodule 22.

The solution disclosed in this embodiment overcomes this problem: The called UE is unable to display the information normally when the calling party information unsupported by the called UE is sent. For example, the MSC server sends the calling party information in Chinese to the called UE only if the called UE supports both Chinese and English and has subscribed to this service. In fact, in addition to process the information in Chinese, depending on the user setting or the UE capabilities, the UE may select the proper and/or best processing mode to bring better user experience.

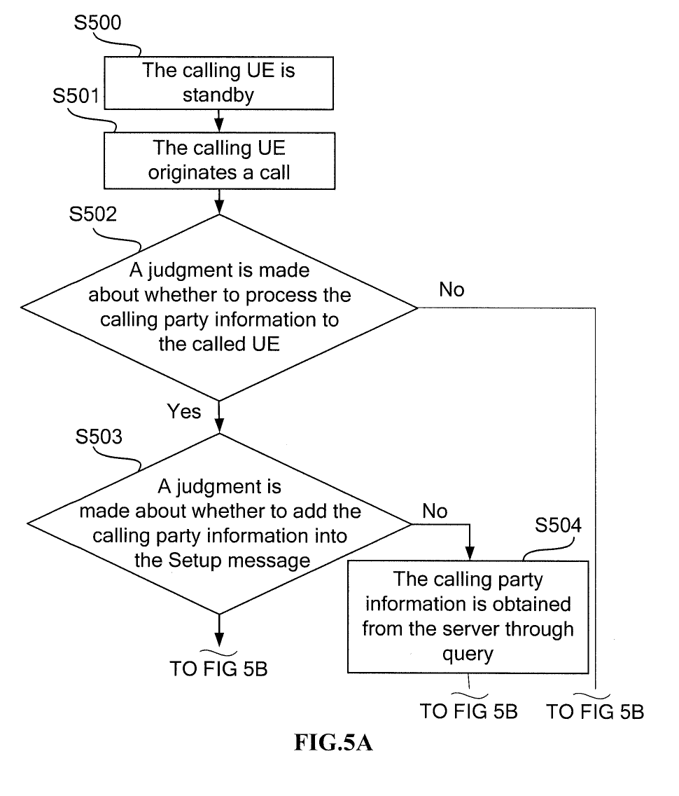

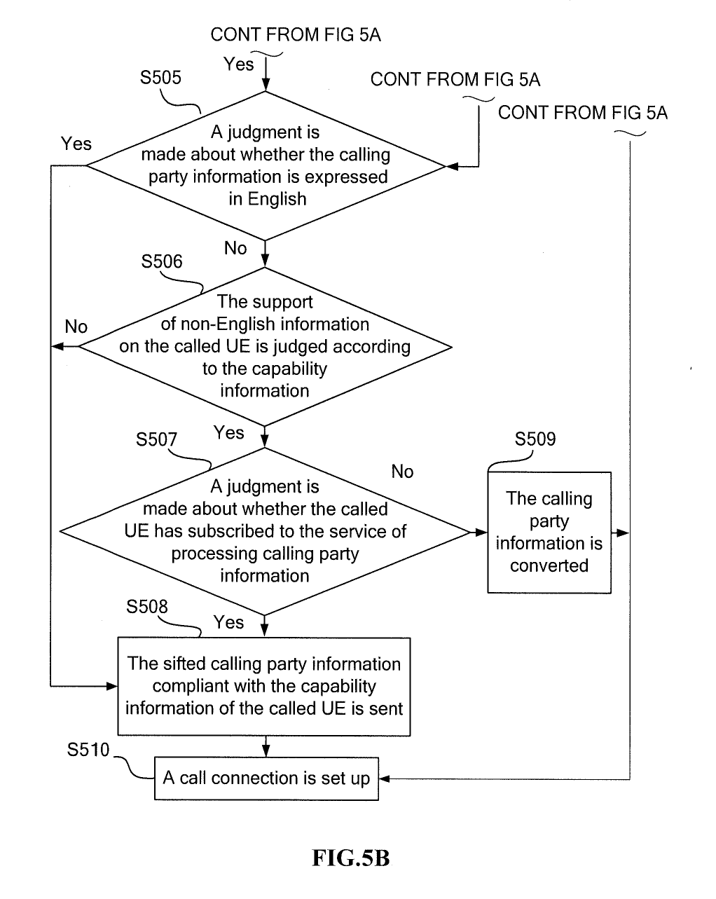

FIGS. 5A and 5B show a flowchart of a method for sending calling party information in embodiment five of the present invention. This embodiment differs from the first embodiment above in the following aspects:

In the first embodiment, the server judges whether the called UE has subscribed to the service of processing calling party information according to the capability information of the called UE. If such is the case, the server sends selected calling party information compliant with the capability information of the called UE, and then sets up a call connection; otherwise, the server sets up the call connection directly.

In this embodiment, if it is determined that the called UE has subscribed to the service of processing calling party information, the server sends the selected calling party information compliant with the capability information of the called UE, and then sets up a call connection; if it is determined that the called UE has not subscribed to the service of processing calling party information, the server converts the calling party information according to the capabilities of the called UE, and sends the converted calling party information to the called UE, and therefore, the converted calling party information complies with the capability information of the called UE, and then the server sets up the connection.

The process of this embodiment includes the following steps:

For easy understanding, it is assumed that the calling party information is in English and Chinese, which should not be construed as limitation to the protection scope of the present invention. In practical application, the calling party information may be in more languages.

Step S500: The calling UE is standby.

Step S501: The calling UE originates a call.

The calling UE sends a call setup message, namely, Setup message, to request setup of a call connection.

A message that carries the calling party information is received from the calling UE.

Step S502: A judgment is made about whether to present the calling party information to the called UE.

In practical application, the judgment is based on the setting by the calling party. That is, the calling party can set whether to present the calling party information to the called UE according to their own decisions on whether to present their information.

If it is determined that the calling party information needs to be sent to the called UE, the process proceeds to step S503.

If it is determined that the calling party information does not need to be sent to the called UE, the process proceeds to step S510.

Step S503: A judgment is made about whether to add the calling party information into the Setup message.

According to the user setting, a judgment is made about whether to add the calling party information into the Setup message sent by the calling UE:

If it is not necessary to add the calling party information, the process proceeds to step S504.

If it is necessary to add the calling party information, the process proceeds to step S505.

Step S504: The calling party information is obtained from the server through query.

Further, if the calling party information needs to be obtained from the server, the calling UE needs to register the calling party information onto the server before this step. The registration process may include the information about whether to send the calling party information to the called UE. If this registration mode is applied, the calling UE needs to query the server about the right of sending the calling party information to the called UE when sending the call setup message. All the foregoing improvements based on the technical conception of the present invention are covered in the protection scope of the present invention.

Step S505: A judgment is made about whether the calling party information is in English.

If the calling party information is pure English information, the calling party information is sent directly, and the process proceeds to step S508.

If the calling party information includes non-English information, the process proceeds to step S506.

It should be noticed that the English mentioned above refers to the language corresponding to the basic processing capabilities owned by the called UE. In practice, the language varies as required or according to the region of the called UE. The change of the language does not affect the protection scope of the present invention.

Step S506: The capability information of the called UE is obtained, and a judgment is made about whether the called UE supports non-English information.

In this step, the capability information of the called UE is obtained, or the message format supported by the network of the called UE is obtained. The judgment about whether the called UE supports non-English information is made on basis of the capability information of the called UE, which is obtained by the calling party side. The detailed obtaining method is described in the second embodiment and the third embodiment, and is not repeated here any further.

If the called UE supports only English information and does not support non-English information, the process proceeds to step S508 and only the calling party information in English is sent.

If the called UE supports non-English information, namely, Chinese texts, video, audio, pictures, or any combination thereof, the process proceeds to step S507.

It should be further noticed that the step of obtaining the capability information of the called UE may occur at any time after the calling UE originates the call and before the judgment about whether the called UE supports non-English information is made, and may be performed between S501 and S506. The technical solution with steps adjusted is also covered in the protection scope of the present invention.

It should be further noticed that the non-English mentioned above refers to the language type or multimedia format corresponding to the advanced processing capabilities of the called UE. In practice, the language type and/or multimedia format varies as required or according to the region of the called UE. Such change based on the technical conception of the present invention is covered in the protection scope of the present invention.

Step S507: A judgment is made about whether the called UE has subscribed to the service of processing calling party information.

If the called UE has not subscribed to the service of processing calling party information, namely, the called party has not activated or has stopped this service, the process proceeds to step S509.

If the called UE has subscribed to the service of processing calling party information, the process proceeds to step S508.

The service of processing calling party information includes: presenting the calling party information, playing the calling party information in a multimedia format, or filtering the incoming calls corresponding to the calling party information, or any combination thereof.

Step S508: The selected calling party information compliant with the capability information of the called UE is sent, and the process proceeds to step S510.

If the capability information of the called UE indicates that the called UE supports only English, the calling party information in English is sent to the called UE.

If the capability information of the called UE indicates that the called UE supports both Chinese and English, the calling party information in Chinese is sent to the called UE.

If the capability information of the called UE indicates that the called UE supports multimedia formats such as audio and/or video, the calling party information in the corresponding multimedia format is sent to the called UE.

If the capability information of the called UE indicates that the called UE supports English and Chinese, and multimedia formats such as audio and/or video, the calling party information in Chinese and the corresponding multimedia format is sent to the called UE.

It should be noticed that if none of the calling party information formats provided by the calling party is supported by the capability information of the called UE, no calling party information is sent. For example, the called UE supports only English format of the calling party information, but the calling UE provides only Chinese format of the calling party information, the calling party information is not sent, thus avoiding display error caused by unsupported format of the calling party information on the called UE.

Step S509: The calling party information is converted according to the capability information of the called UE. The server provides a conversion function which converts the calling party information into a format supported by the called UE or the called network.

The calling party information is converted according to the capability information of the called UE, including:

converting the message that carries the calling party information to the capability information of the called UE; or

converting the content format of the calling party information according to the capability information of the called UE.

When the calling UE and the called UE are located in different networks, the message that carries the calling party information is converted.

The conversion of the message that carries the calling party information refers to conversion between any two of the following messages: user-to-user message element in an Initial Address Message (IAM) message of the CS domain, Call-Infor message element in an Invite message in a PS-domain SIP protocol, message element in CS-domain USSD, and message element in a CS-domain Facility message.

Step S510: A call connection is set up.

The content of this step is not intended as primarily protected content of the present invention, and is not described in any more detail.

In the example given above, it is assumed that the calling party information in Chinese is preferred. In practice, in addition to presentation of the information, the processing further includes: playing the calling party information in a multimedia format such as a ring tone, triggering the ring tone defined by the calling party or the called party, filtering the calling party information, and judging whether to filter out the incoming call according to the result of matching between the calling party information and the information stored in the called UE. The server provides a conversion function which converts the calling party information into a format supported by the called UE or the called network.

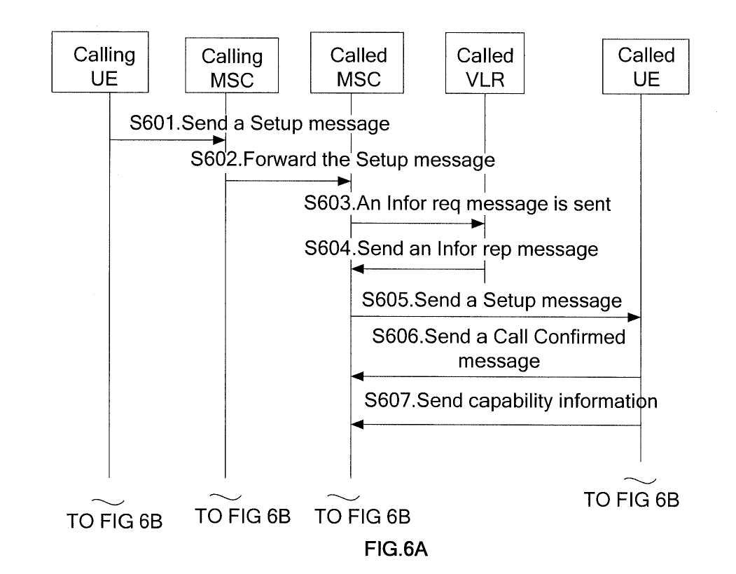

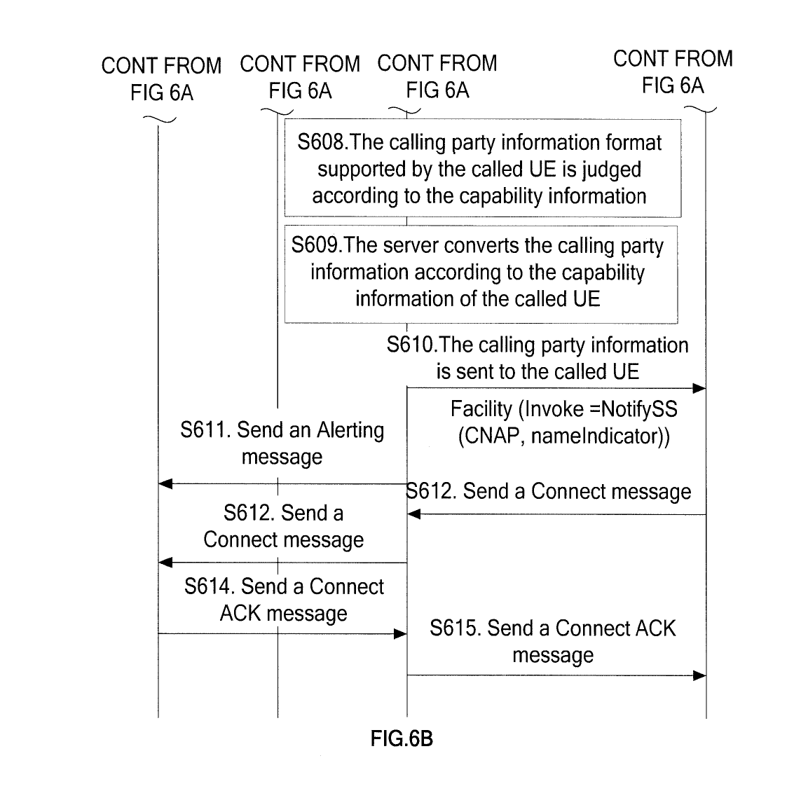

FIGS. 6A and 6B show a method for requesting the called UE to feed back capability information and the UE processing calling party information accordingly in embodiment six of the present invention.

The steps of the method for a UE to process calling party information compliant with the capability information requested from the called UE are almost the same as the second embodiment, and are not repeated here any further. In step S609 in this embodiment, if the called UE does not support the format of the calling party information, the server converts the calling party information into the format supported by the called UE according to the capability information of the called UE, and then sends the converted calling party information to the called UE.

In this embodiment, after a Setup message is sent to the called UE, if the calling party has provided the calling party information and allows sending of the calling party information to the called UE, the network requires the called UE to return a message, which carries the capability information of the called UE and indicates whether the called UE has subscribed to this service. The message that carries such information may be Alerting message, Call Confirmed message, Call Proceeding message, or Facility message.

It should be noticed that the capability information of the called UE includes: hardware information of the called UE, and/or software information of the called UE, and/or version information of the called UE, and/or language information of the called UE, and/or an indication about whether the called UE has subscribed to the service of processing calling party information, and/or an indication about whether the called UE has activated the service of processing calling party information, and/or subscriber profile, and/or subscriber preferences, and/or subscriber level.

In this embodiment, an Alerting message carries an indication of capability information of the UE and/or an indication about whether the called UE has subscribed to this service. Therefore, the network server knows whether the called UE supports Chinese and/or English, obtains the multimedia formats supported by the called UE, and knows whether the called UE has subscribed to this service.

The UE processes the calling party information according to the returned capability information. In addition to presentation of the information, the processing further includes:

playing the calling party information in a multimedia format such as a ring tone;

triggering the ring tone defined by the calling party or the called party;

filtering the calling party information; and

judging whether to filter out the incoming call according to the result of matching between the calling party information and the information stored in the called UE.

The solution disclosed in this embodiment overcomes this problem: The called UE is unable to display the information normally when the calling party information unsupported by the called UE is sent. For example, the MSC server sends the calling party information in Chinese to the called UE only if the called UE supports both Chinese and English and has subscribed to this service. In addition to processing the information in Chinese, depending on the user setting or the UE capabilities, the UE may select the proper and/or best processing mode to bring better user experience. The server provides a conversion function which converts the calling party information into a format supported by the called UE or the called network.

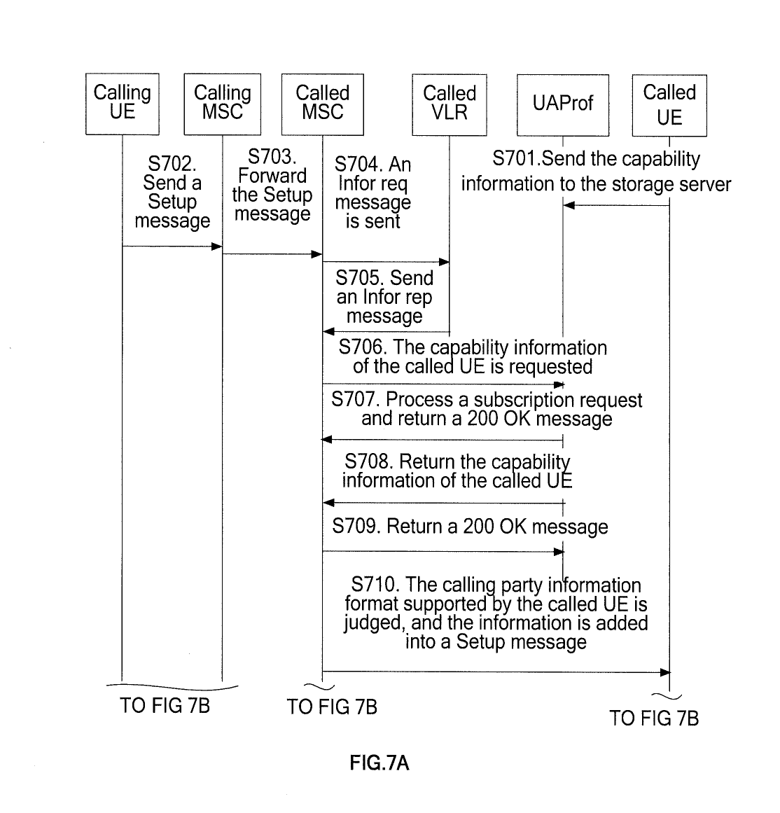

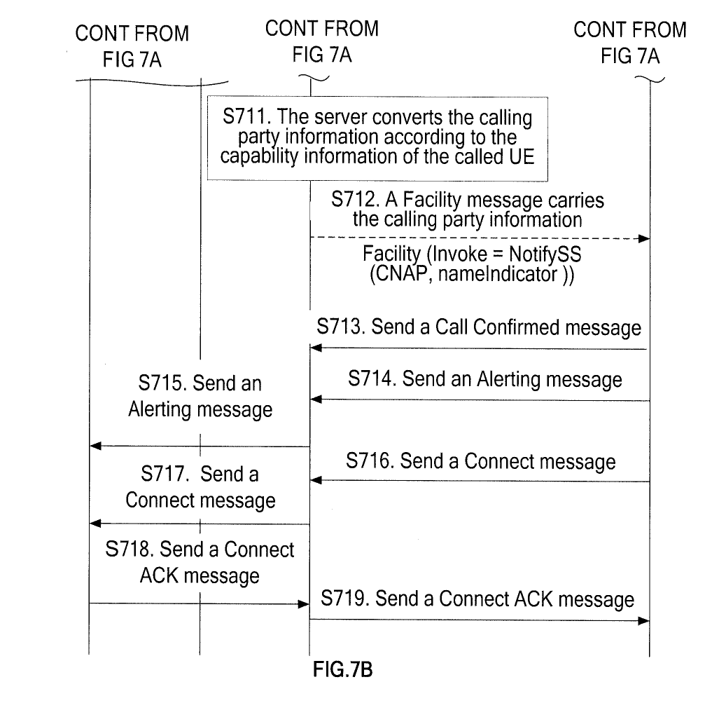

FIGS. 7A and 7B show a flowchart for retrieving registered capability information and the UE processing calling party information accordingly in embodiment seven of the present invention.

The steps of the method for a UE to process calling party information compliant with the capability information requested from the called UE are almost the same as the third embodiment, and are not repeated here any further. In step S711 in this embodiment, if the called UE does not support the format of the calling party information, the server converts the calling party information into the format supported by the called UE according to the capability information of the called UE, and then sends the converted calling party information to the called UE.

The UE processes the calling party information according to the returned capability information. In fact, in addition to presentation of the information, the processing further includes:

playing the calling party information in a multimedia format such as a ring tone;

triggering the ring tone defined by the calling party or the called party;

filtering the calling party information; and

judging whether to filter out the incoming call according to the result of matching between the calling party information and the information stored in the called UE.

In this embodiment, if the called UE has activated this service, the called UE reports its capability information to the storage server such as UAProf server. The capability information includes: support of the calling party information in Chinese and/or English, and/or information about whether the called UE has subscribed to this service, and/or supported multimedia message format. In this way, if the calling party allows presentation of the calling party information, and/or the called party has subscribed to this service, and/or the calling party provides displayable calling party information, the server queries the storage server about capability information of the called UE, judges whether to send the calling party information to the called UE, and judges the format of the calling party information normally receivable by the called UE.

The MSC server converts the proper calling party information or the message that carries the calling party information if the MSC server supports such conversion. In this way, the called UE can receive the calling party information normally. The conversion includes: converting messages, converting the format of the calling party information supported by the called UE, converting the heterogeneous network message, and converting the calling party information into a format acceptable to the called UE.

In addition to processing the information in Chinese, depending on the user setting or the UE capabilities, the UE may select the proper and/or best mode of processing the calling party information.

The server provides a conversion function which converts the calling party information into a format supported by the called UE or the called network.

It should be noticed that the methods disclosed in the fifth embodiment to the seventh embodiment above are applicable to the service of processing calling party information in the CS domain calls, and/or videophone, and/or message sessions.

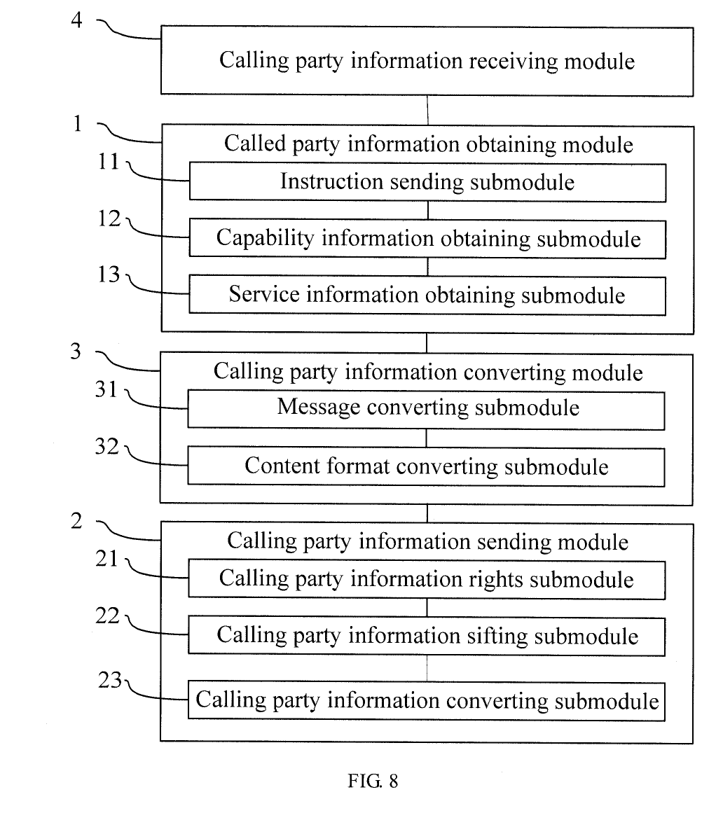

FIG. 8 shows a structural diagram of an apparatus for a UE to process calling party information in embodiment eight of the present invention. The apparatus includes:

a called party information obtaining module 1, adapted to obtain capability information of called UE;

a calling party information converting module 3, adapted to convert the calling party information obtained from calling UE according to the capability information obtained by the called party information obtaining module 1; and

a calling party information sending module 2, adapted to send the calling party information compliant with the capability information obtained by the called party information obtaining module 2 to the called UE so that the called UE can process the calling party information.

The called information obtaining module 1 is further adapted to obtain information about whether the called UE has activated the service of processing the calling party information, and includes:

an instruction sending submodule 11, adapted to send to the called UE or server an instruction of obtaining the capability information of the called UE and/or obtaining information about whether the called UE has activated the service of processing calling party information;

a capability information obtaining submodule 12, adapted to obtain the capability information of the called UE through the message returned by the called UE or server; and

a service information obtaining submodule 13, adapted to obtain information about whether the called UE has activated the service of processing calling party information through the message returned by the called UE or server.

The calling party information sending module 2 further includes:

a calling party information rights submodule 21, adapted to judge whether the called UE is entitled to process calling party information;

a calling party information selecting submodule 22, adapted to select the calling party information compliant with the capability information or the message that carries the calling party information according to the capability information obtained by the called party information obtaining module 1 if the calling party information rights submodule 21 determines that the called UE is entitled to process the calling party information; and

a calling party information converting submodule 23, adapted to convert the calling party information or message selected by the calling party information selecting submodule 22.

The apparatus for a UE to process calling party information further includes:

a calling party information receiving module 4, adapted to receive a message that carries the calling party information from the calling UE.

The calling party information converting module 3 further includes:

a message converting submodule 31, adapted to convert the message that carries the calling party information according to the capability information obtained by the called party information obtaining module 1.

The calling party information converting module 3 further includes:

a content format converting submodule 32, adapted to convert the content format of the calling party information according to the capability information obtained by the called party information obtaining module 1.

The technical solution provided in this embodiment brings these benefits: The calling party information compliant with the capability information of the called UE is sent to the called UE and processed by the called UE. Therefore, the called UE can process the calling party information normally, it is avoided that information resources are wasted due to incapability of the called UE in processing the calling party information, and the user experience is improved. Meanwhile, the server provides a conversion function which converts the calling party information into a format supported by the called UE or the called network.

Through the descriptions of the preceding embodiments, those skilled in the art may understand that the present invention may be implemented by hardware only or by software and necessary universal hardware. However, in most cases, using software and necessary universal hardware are preferred. Based on such understandings, all or part of the technical solution under the present invention that makes contributions to the prior art may be essentially embodied in the form of a software product. The software product may be stored in a storage medium. The software product includes a number of instructions that enable a computer device (mobile phone, personal computer, server, or network device) to execute the methods provided in the embodiments of the present invention.

It should be noted that the above descriptions are merely preferred embodiments of the present invention, and person having ordinary skill in the art may make various improvements and refinements without departing from the spirit of the invention. All such modifications and refinements are intended to be covered by the present invention.

What is claimed is:

1. A method for a User Equipment (UE) to process calling party information, comprising:
obtaining capability information of a called UE; and
sending the calling party information compliant with the capability information to the called UE so that the called UE can process the calling party information.

2. The method for a UE to process calling party information according to claim 1, wherein the obtaining of the capability information of the called UE is:
retrieving the capability information from a server, wherein the capability information is registered by the called UE into the server beforehand; or
requesting the called UE to feed back the capability information of the called UE; or
obtaining information about message formats supported by a network that covers the called UE.

3. The method for a UE to process calling party information according to claim 2, wherein the capability information of the called UE comprises at least one type of:
hardware information of the UE, software information of the UE, version information of the UE, language information of the UE, an indication about whether the called UE has subscribed to a service of processing the calling party information, an indication about whether the called UE has activated the service of processing the calling party information, subscriber profile, subscriber preferences, and subscriber level.

4. The method for a UE to process calling party information according to claim 1, further comprising a step of judging whether the called UE is entitled to process the calling party information:
determining that the called UE is entitled to process the calling party information if a calling UE allows the called UE to process the calling party information, and/or the called UE has activated the service of processing the calling party information, and/or the capability information of the called UE fulfills requirements of the service of processing the calling party information, and/or the called UE has subscribed to the service of processing the calling party information.

5. The method for a UE to process calling party information according to claim 1, wherein the calling party information may be at least one type of:
a text in multiple languages such as English and Chinese, or voice, or video, or picture information, and identifier information.

6. The method for a UE to process calling party information according to claim 1, wherein:
before obtaining the capability information of the called UE, the method further comprises:
receiving a message that carries the calling party information from a calling UE.

7. The method for a UE to process calling party information according to claim 1, wherein: before sending the calling party information compliant with the capability information to the called UE so that the called UE can process the calling party information, the method further comprises:
converting the calling party information obtained from the calling UE according to the capability information of the called UE.

8. The method for a UE to process calling party information according to claim 1, wherein the converting of the calling party information according to the capability information of the called UE is:
converting the message that carries the calling party information according to the capability information of the called UE; or
converting a content format of the calling party information according to the capability information of the called UE.

9. The method for a UE to process calling party information according to claim 8, wherein the converting of the message that carries the calling party information is:
if the calling UE and the called UE are located in different networks, the message that carries the calling party information is converted between any two of the following types of messages:
user-to-user message element in an Initial Address Message (IAM) message of a Circuit-Switched (CS) domain, Call-Infor message element in an Invite message in a Packet-Switched (PS)-domain Session Initiation Protocol (SIP), message element in CS-domain Unstructured Supplementary Service Data (USSD), and message element in a CS-domain Facility message.

10. The method for a UE to process calling party information according to claim 2, wherein the obtaining of the capability information of the called UE is:
obtaining the capability information by receiving a capability feedback message, wherein the capability feedback message is at least one of: an Alerting message that carries the capability information of the called UE, a Call Proceeding message, a Call Confirmed message, a Facility message, and an independent capability feedback message.

11. The method for a UE to process calling party information according to claim 1, wherein the sending of the calling party information compliant with the capability information to the called UE is:
if the capability information indicates that the called UE supports only one language, sending the calling party information in this language to the called UE;
if the capability information indicates that the called UE supports multiple languages, sending the calling party information in a language preferred by the called UE to the called UE;
if the capability information indicates that the called UE supports multiple languages and multimedia, sending the calling party information in the language preferred by the called UE and/or the calling party information in a multimedia format to the called UE; or
if the capability information indicates that the called UE supports multimedia, sending the calling party information in a multimedia format supported by the called UE to the called UE.

12. The method for a UE to process calling party information according to claim 11, wherein the sending of the calling party information compliant with the capability information to the called UE is:
sending a message that carries the calling party information compliant with the capability information to the called UE; or
registering the calling party information onto a server so that the called UE can query the server about the calling party information compliant with the capability information.

13. The method for a UE to process calling party information according to claim 1, wherein the called UE processes the calling party information in at least one way of:
presenting the calling party information, playing the calling party information in a multimedia format, and filtering incoming calls corresponding to the calling party information,.

14. An apparatus for a User Equipment (UE) to process calling party information, comprising:
a called party information obtaining module, adapted to obtain capability information of called UE;
a calling party information converting module, adapted to convert the calling party information obtained from calling UE according to the capability information obtained by the called party information obtaining module; and
a calling party information sending module, adapted to send the calling party information compliant with the capability information obtained by the called party information obtaining module to the called UE after the calling party information converting module converts the calling party information so that the called UE can process the calling party information.

15. The apparatus for a UE to process calling party information according to claim 14, wherein: the called party information obtaining module is further adapted to obtain information about whether the called UE has activated a service of processing the calling party information, and comprises:
an instruction sending submodule, adapted to send to the called UE or a server an instruction of obtaining the capability information of the called UE and/or obtaining the information about whether the called UE has activated the service of processing calling party information;
a capability information obtaining submodule, adapted to obtain the capability information of the called UE through a message returned by the called UE or server; and
a service information obtaining submodule, adapted to obtain the information about whether the called UE has activated the service of processing the calling party information through the message returned by the called UE or server.

16. The apparatus for a UE to process calling party information according to claim 14, wherein the calling information sending module further comprises:
a calling party information rights submodule, adapted to judge whether the called UE is entitled to process the calling party information; and
a calling party information selecting submodule, adapted to select the calling party information compliant with the capability information and/or a message that carries the calling party information according to the capability information obtained by the called party information obtaining module if the calling party information rights submodule determines that the called UE is entitled to process the calling party information.

17. The apparatus for a UE to process calling party information according to claim 14, wherein the calling information converting module further comprises:
a message converting submodule, adapted to convert a message that carries the calling party information according to the capability information obtained by the called party information obtaining module.

18. The apparatus for a UE to process calling party information according to claim 14, wherein the calling information converting module further comprises:
a content format converting submodule, adapted to convert content format of the calling party information according to the capability information obtained by the called party information obtaining module.
